(19) United States
(12) Patent Application Publication
(10) Pub. No.: US 2009/0050430 A1
(43) Pub. Date: Feb. 26, 2009

(54) DEVICE FOR AN ASSEMBLY OF A FRICTION PLATE FOR A LOCKUP CLUTCH AND A METHOD OF ITS ASSEMBLY

(75) Inventors: Masaki TOMINAGA, Kasugai-shi (JP); Tsutomu Inagaki, Kasugai-shi (JP)

Correspondence Address: SUGHRUE MION, PLLC, 2100 PENNSYLVANIA AVENUE, N.W., SUITE 800, WASHINGTON, DC, 20037, US

(73) Assignee: AISIN KAKO KABUSHIKI KAISHA, Toyota-shi (JP)

(21) Appl. No.: 12/193,929

(22) Filed: Aug. 19, 2008

(30) Foreign Application Priority Data
Aug. 21, 2007 (JP) 2007-214942

(51) Int. Cl. F16D 33/00

(52) U.S. Cl. 192/3.28

(57) ABSTRACT

It makes it possible to be able to operate at high velocity and making the square measure of setting small.

It is capable of inserting inside the groove of the base component 30 which forms the circle ring groove 31 which places the several pieces of the fan-shaped friction material 10, the supporting component of the lower end side 21 which props up the lower edge of the fan-shaped friction material 10 which is placed at the every designated circumference of the circle ring groove 31 of the base component 30, the supporting component of the upper end side 22 which props up the upper edge of that fan-shaped friction material 10 and the circle ring groove 31 of the base component 30, the several pieces of the fan-shaped friction material 10 is that it fully provides the pressing component 50 which compresses the several pieces of the fan-shaped friction material 10 to intend to make into the circle formed friction material 10A while retracting the supporting component of the lower end side 21 and the supporting component of the upper end side 22 and the fan-shaped friction material 10 will not be transferred because of the centrifugal force even in case of supplying the several pieces of the fan-shaped friction material 10 by rotating them successively so that the operation at the high velocity becomes possible. Moreover, the joining density of the edge part of the several pieces of the fan-shaped friction material 10 which is contiguous becomes high and there is no possibility that the mechanical intensity lowers at the boundary line of the fan-shaped friction material 10.

### BACKGROUND OF THE INVENTION

1. Field of the Invention

This invention relates to a device for an assembly of a friction plate for a lockup clutch of a torque converter and a method of its assembly. Especially, this invention relates to a device for an assembly that a plurality of friction materials are connected to a core metal and relates to a method of its assembly.

2. Description of the Related Art

In Japanese Patent Publication No. 3614763, there is described a technique related to a friction plate for a lockup clutch that a plurality of friction materials are connected to a conventional core metal and related to a method of its production.

The Japanese Patent Publication No. 3614763 discloses the device for assembly and a method of its assembly that regarding the method to manufacture the friction plate (F) which is made by connecting the circle ring formed friction lining (24) which has the flat friction surface on the side of the core metal (23) (Here, numeric symbol within the round brackets here indicates the component part of figure of the Japanese Patent Publication No. 3614763), the process that the several pieces of the fan-shaped lining segment (24a) which is punched out of the friction lining material tape (38) temporarily positions at the circle ring form on the whole that is piled on top of the index table (32) without laying on top of each other and that the process that the temporal arrangement of the lining segment (24a) is corrected to the circle ring form which the gap between the each lining segment (24a) is removed by moving the several pieces of the lining segment (24a) which is temporarily arranged on top of the index table (32) all together toward the center and that the process that the several pieces of the lining segment (24a) that the arrangement is corrected to the circle ring form is connected on the side of the core board (23) are provided.

On the other hand, regarding the Japanese Patent Publication No. 3614763, it is to maintain a group of the lining segment (24a) which is corrected the arrangement to the arrangement correction material (58) while temporarily arranging the several pieces of the fan-shaped lining segment (24a) which are punched out of the friction lining material tape (38) with temporal arranged station of the lining segment (S1) to the circle ring form on the whole on top of the index table without laying them on top of each other, transferring the several pieces of the lining segment (24a) which are temporarily arranged on top of the index table (32) with the arrangement correction station of the lining segment (S2) all together toward the center of the index table (32) with the several pieces of arrangement correction material (58) which are positioned on the outer circumference of the index and then correcting the temporal arrangement of the lining segment (24a) to the circle ring form which the gap is removed from between the each lining segment (24a).

In consequence, there is necessity that the index tape (32) of the temporal arrangement station of the lining segment (S1) increases the size of the diameter, and after that, the gap between the several pieces of the fan-shaped lining segment (24a) which is temporarily arranged to the circle ring form on the whole with the arrangement correction station of the lining segment (S2) is slid to narrow it down so that the square measure within the plant that a device for an assembly of a friction plate for the lockup clutch had no choice but to become wide.

What is more, it is positioned on a flat surface because of the necessity of making it slide to narrow down the gap of the several pieces of the fan-shaped lining segment (24a) which is temporarily arranged to the circle ring form on the whole on top of the index table (32). Hereupon, when increasing the number of the revolution per minute of the index table in order to enhance the productivity, the centrifugal force affects to the lining segment (24a) so that an abnormality occurs to the gap of the each fan-shaped lining segment (24a) and when making it slide to narrow down the gap of the several pieces of the fan-shaped lining segment (24a), some pieces are drifted away so that there is possibility that the diameter of the lining segment can not be fixed precisely.

Thereupon, the invention has been done in order to resolve this kind of poor functioning and it made an operation of high velocity possible, in addition, having to propose a provision of a device for an assembly of a friction plate for the lockup clutch which is able to diminish the positioning square measure and the method of its assembly are its object.

### BRIEF SUMMARY OF THE INVENTION

According to a first aspect of the invention, there is provided a device for an assembly of a friction plate for the lockup clutch comprising a supporting component of a lower end side, the supporting component of the lower end side props a base component that forms a circular ring groove, the circular ring groove arranges a plurality of fan-shaped friction materials in a circular ring shape, the supporting component of the lower end side also props a lower end of the fan-shaped friction materials mentioned above arranged at prescribed intervals of circumferences of the above circular ring groove of the above base component, and a supporting component of a upper end side, the supporting component of the upper end side props a upper end of the fan-shaped friction materials mentioned above arranged at prescribed intervals of circumferences of the above circular ring groove of the above base component; and a pressing component member, the pressing component member is capable of being inserted into inside of the above circular ring groove of the above base component, the pressing component member presses to make the above plurality of the fan-shaped friction materials be in a circular shape while retracting a plurality of fan-shaped friction materials arranged in the above circular ring groove side-by-side with the above supporting component of the lower end side and the above supporting component of the upper end side.

Hereupon, the base component which forms the circle ring groove is the one to be the die which arranges the several pieces of the fan-shaped friction material to the circle ring form and is basically desirable if the form is which succeeds in having a circle ring groove.

On the other hand, the supporting component of the lower end side which props up the lower edge of the above mentioned fan-shaped friction material is desirable to form the upper edge as nearly the groove of a right angle, but then it is desirable to be as a plane surface as well as a convex surface which forms a small projection. Next, the supporting component of the upper end side which props up the upper edge of the above mentioned fan-shaped friction material is desirable to form the upper edge as a plane surface or nearly a right angle, but then it is possible to be made a partial concavity.

Furthermore, the above mentioned pressing component is desirable when it is capable of inserting inside the above mentioned circle ring groove of the base component as the above mentioned die and when it is to compress to intend making the both surfaces plane surfaces while the several pieces of the fan-shaped friction material which are arranged in line at the above mentioned circle ring groove are made as circle by that the both the above mentioned supporting component of the lower end side and the supporting component of the upper end side are retracted as the edge parts of one another contact to form as a die of the circle form as well as the above mentioned circle ring groove of the base component as the above mentioned die.

According to a second aspect of the invention, there is provided a device for an assembly of a friction plate for the lockup clutch, furthermore, the above mentioned pressing component fully provide the work transferring method which the location of the several pieces of the fan-shaped friction material which is formed into the above mentioned circle form is transferred after absorbing the above mentioned several pieces of the fan-shaped friction material which is formed into the circle form and absorbing at the condition that the above mentioned several pieces of the fan-shaped friction material are formed into the circle form.

Hereupon, the method of the above mentioned work transferring is desirable when it is to form the absorbing head and the air conduit which absorb the several pieces of the fan-shaped friction material which are formed into circle form on the above mentioned pressing component. Moreover, the transferring the location of the several pieces of the fan-shaped friction material which are formed into the above mentioned circle form is desirable when it transfers to the process which the next processing can be conducted, therefore the exclusive machine, a robot or transferring machine etc. are all acceptable for transfer.

According to a third aspect of the invention, there is provided the circle ring groove of the above mentioned base component of a device for an assembly of a friction plate for the lockup clutch which is the one that is formed into a trapezoid that the upper side of the section form of the diameter direction is made wider. Hereupon, the trapezoid refers to that the depth is standardized and the width of the upper side is wider than the one of the lower side.

According to the fourth aspect of the invention, there is provided a device for an assembly of a friction plate for the lockup clutch that the trapezoid which is the section formed of the diameter direction of the above mentioned base component is what the side of the outer circumference does not change and only the side of the internal circumference is changed. That is, hereupon, the trapezoid is what the outer circumference side does not be transformed and the width of the upper side of only the internal circumference side is wider than the lower side.

According to the fifth aspect of the invention, there is provided the assembly method of the friction plate for the lockup clutch that the supporting component of the lower end side which props up the lower edge of the fan-shaped friction material which is positioned at every designated circumference of the circle ring groove which is formed on the base component at the process of setting the supporting component and as well as the supporting component of the upper end side which props up the upper edge of the above mentioned fan-shaped friction material which is positioned at every designated circumference are set at each designated height and the several pieces of the fan-shaped friction material of the above mentioned circle ring groove at the supplying process are positioned as nearly a circle ring form to make one another opposite inclination at the upper edge of the supporting component of the upper end side and the contiguous supporting component of the lower end side, and what is more the several pieces of the fan-shaped friction material which are formed in a line at the above mentioned circle ring groove on the compressing process is to be compressed to intend to make the circle formed friction material which the both sides are the smooth surface by retracting the above mentioned supporting component of the lower end side and the above mentioned supporting component of the upper end side and by contacting the edge part of the above mentioned several pieces of the fan-shaped friction material. Hereupon, the setting process of the above mentioned supporting component is that the above mentioned supporting component of the lower end side and the above mentioned supporting component of the upper end side are set to the designated height so that the fan-shaped friction material is able to be set at the designated angle on the supporting component of the lower end side and the supporting component of the upper end side. The above mentioned supporting component of the lower end side and the above mentioned supporting component of the upper end side are acceptable if those are controlled to be at the each one's designated height. What is more, the above mentioned supplying process is that the several pieces of the fan-shaped friction material within the above mentioned circle ring groove are positioned to the circle ring form on top of the upper edge of the supporting component of the upper end side and the contiguous supporting component of the lower end side to make one another to the opposite inclination. This could be both that the fan-shaped friction material which one another is oppositely inclined from the single channel of supply and the fan-shaped friction material which one another is oppositely inclined is supplied from 2 channels of supply.

Furthermore, the above mentioned pressing process is to compress the several pieces of the fan-shaped friction material which are formed in a line at the above mentioned circle ring groove to make a circle form by retracting the above mentioned supporting component of the lower end side and the supporting component of the upper end side as well as by contacting the edge part of the above mentioned several pieces of the fan-shaped friction material, therefore the retraction of the above mentioned supporting component of the lower end side and the supporting component of the upper end side can be both that is contracted along with the pressing and that is made compressed while retracting the above mentioned supporting component of the lower end side and the supporting component of the upper end side aggressively.

According to the sixth aspect of the invention, there is provided the method of assembly of the friction plate for the lockup clutch, moreover, is what fully provides the work transferring process that transfers the position of the several pieces of the fan-shaped friction material which are formed into the above mentioned circle form while the above mentioned several pieces of the fan-shaped friction material which are formed into the circle form are absorbed at the condition of that are formed into the above mentioned circle form after the above mentioned compressing process.

Hereupon, the work transferring process is that is formed the absorbing head and the pipe conduit which absorb the several pieces of the fan-shaped friction material which are formed into the circle form on the above mentioned compressing component and it is desirable that is to transfer the positioned of the several pieces of the fan-shaped friction material which are formed on the above mentioned circle form to others, moreover the exclusive machine, the robot and transferring machine etc. are all acceptable.

According to a seventh aspect of the invention, there is the supplying process which is mentioned above of the method for the assembly of the friction plate for the lockup clutch, it is to supply the fan-shaped friction material that one another are inclined oppositely from the single channel of supply. Hereupon, the single channel of supply is able to supply the friction material at the same time as to punch out the single friction material.

According to the eighth aspect of the invention, there is provided the above mentioned supplying process of the method of the assembly of the friction plate for the lockup clutch, it is to supply the fan-shaped friction material that one another is inclined oppositely from 2 channels of supply. Hereupon, the above mentioned 2 channels of supply signify that they hold 2 systems of the channel of supply of the fan-shaped friction material that one another is inclined oppositely.

According to the ninth aspect of the invention, there is provided the above mentioned setting process for the supporting component of the method of the assembly of the friction plate for the lockup clutch which is to be launched overlapping with the work transferring process on the continuous operation.

Hereupon, the above mentioned continuous operation signifies the operation as an assembly line of the friction plate for the lockup clutch. What is more, to be launched overlapping with the work transferring process signifies that the setting process of the above mentioned supporting component and the work transferring process are partially, or totally launched overlapped.

According to the first aspect of the invention, there is provided a device for an assembly of a friction plate for the lockup clutch which is that the supporting component of the lower end side which props up the lower edge of the fan-shaped friction material which is positioned at every designated circumference of the circle ring groove which is formed on the base component and as well as the supporting component of the upper end side which props up the upper edge of the above mentioned fan-shaped friction material which is positioned at every designated circumference are set at the each designated height, the several pieces of the fan-shaped friction material are positioned in the circle form at the contiguous upper edge of the supporting component of the lower end side and the upper edge of the supporting component of the upper end side as that one another is inclined oppositely and moreover the several pieces of the fan-shaped friction material which are formed in a line on the above mentioned circle ring groove are that the above mentioned supporting component of the lower end side and the supporting component of the upper end side are retracted and the edge part of the above mentioned several pieces of the fan-shaped friction material is compressed to make it into contacted circle form.

In consequence, the several pieces of the fan-shaped friction material are able to be taken out as the circle form without making use of wider space than the circle ring form which is formed on the base component so that it can be manufactured with that the setting square measure of the device is restrained small. What is more, the circle ring groove which is formed on the base component, differs to the existed examples, is the one which is fixed and is the one which does not have surplus space, therefore the operation at high velocity becomes possible because the fan-shaped friction material does not be transferred due to the centrifugal force even in case of supplying the several pieces of the fan-shaped friction material by revolving it consecutively.

Also, there is no possibility that the mechanical intensity lowers at the boundary line of the fan-shaped friction material because the several pieces of the friction material are positioned at the circle ring groove as one another inclines oppositely and the contiguous several pieces of the fan-shaped friction material are combined as circle form so that the contact force of the edge part becomes high.

According to the second aspect of the invention, there is provided a device for an assembly of a friction plate for the lockup clutch, what is more, able to raise the finishing precision because the above mentioned pressing component fully provides the means of the work transferring which transfers the several pieces of the fan-shaped friction material which are formed into the above mentioned circle form by absorbing the above mentioned several pieces of the fan-shaped friction material which are formed into circle form and by absorbing the above mentioned several pieces of the fan-shaped friction material at circle form with the condition of that are formed, therefore in addition to the effect which is stated in claim 1, it can be utilized without the form of the circle form getting out of shape by absorbing the above mentioned several pieces of the fan-shaped friction material at the condition of being formed into the circle form in case of transferring them to the next working process.

According to the third aspect of the invention, there is provided the circle ring groove of the above mentioned base component of a device for an assembly of a friction plate for the lockup clutch that the section form of the dimension direction is formed into the trapezoid which nearly the upper side is wider so that, in addition to the effect which is stated in claim 1 or claim 2, it is guided by the side surface while being transferred to the specified molding position, that is to the molding position of the bottom side and then the several pieces of the fan-shaped friction material can be formed into the circle form precisely.

According to the fourth aspect of the invention, there is provided the trapezoid of the section form of the dimension direction of the above mentioned base component of a device for an assembly of a friction plate for the lockup clutch that the outer circumference side does not change and the only internal circumference side is changed, so that in addition to the effect which is stated in claim 3, the several pieces of the fan-shaped friction material can be formed into the circle form precisely because it is guided at the outer circumference side only by setting the outer circumference of the circle ring groove of the above mentioned base component as the standard side even if the centrifugal force affects.

According to the fifth aspect of the invention, there is provided the method of the assembly of the friction plate for the lockup clutch which is to compress in order to make it into the circle form by that the supporting component of the lower end side which props up the lower edge of the fan-shaped friction material which is positioned at the every designated circumference of the circle ring groove which is formed on the base component and as well as the supporting component of the upper end side which props up the upper edge of the above mentioned fan-shaped friction material which is positioned at every designated circumference are set at the every designated height and the several pieces of the fan-shaped friction material of the circle ring groove which is formed on the above mentioned base component are positioned as the circle ring form at the upper edge of the supporting component of the upper end side and the contiguous supporting component of the lower end side as one another inclines oppositely and that the several pieces of the fan-shaped friction material which are formed in a line on the above mentioned circle ring groove is that the edge part of the above mentioned several pieces of the fan-shaped friction material is contacted while the above mentioned supporting component of the lower end side and the supporting component of the upper end side are retracted.

In consequence, the several pieces of the fan-shaped friction material are able to be taken out as the circle form without making use of wider space than the circle ring form which is formed on the base component so that it can be manufactured with that the setting square measure of the device is restrained small. What is more, the circle ring groove which is formed on the base component, differs to the existed examples, is the one which is fixed and is the one which does not have surplus space, therefore the operation at high velocity becomes possible because the fan-shaped friction material does not be transferred due to the centrifugal force even in case of supplying the several pieces of the fan-shaped friction material by revolving it consecutively.

Also, there is no possibility that the mechanical intensity lowers at the boundary line of the fan-shaped friction material because the several pieces of the friction material are positioned at the circle ring groove as one another inclines oppositely and the contiguous several pieces of the fan-shaped friction material are combined as circle form so that the contact force of the edge part becomes high.

According to the sixth aspect of the invention, there is provided the method of the assembly of the friction plate for the lockup clutch, what is more, after the above mentioned compressing process, able to raise the finishing precision because it fully provides the work transferring process which the above mentioned several pieces of the friction material which are formed into the circle form are absorbed at the condition of that are formed into the above mentioned circle form and the position of the several pieces of the fan-shaped friction material which are formed into the above mentioned circle form is transferred, therefore in addition to the effect which is stated in claim 5, it can be utilized without the form of the circle form getting out of shape by absorbing the above mentioned several pieces of the fan-shaped friction material at the condition of being formed into the circle form in case of transferring them to the next working process.

According to the seventh aspect of the invention, there is provided the supplying process as mentioned above for the method of the assembly of the friction plate for the lockup clutch, it is to supply the fan-shaped friction material which one another are inclined oppositely from the single channel of supply, therefore in addition to the effect which is stated in claim 5 or claim 6, the whole device can be composed in a compact way.

According to the eighth aspect of the invention, there is provided the supplying process as it is mentioned above for the method of the assembly of the friction plate for the lockup clutch, it is to supply the fan-shaped friction material which one another inclines identically from 2 channels of supply, therefore in addition to the effect which is stated in claim 5 or claim 6, the fan-shaped friction material can be set accurately and the precise finishing is able to be enforced.

According to the ninth aspect of the invention, there is provided the setting process of the above mentioned supporting component of the method of the assembly of the friction plate for the lockup clutch, in the continuous operation, is to be launched overlapping with the work operation process so that, in addition to the effect which is stated in claim 6, the productivity is able to be raised.

### BRIEF DESCRIPTION OF THE SEVERAL VIEWS OF THE DRAWINGS

FIG. 1 is a diagram which indicates the movement in the whole of the device for the assembly of the friction plate for the lockup clutch of the first embodiment of the invention.

FIG. 2 is a cross sectional view by the cutting line A-A of FIG. 1.

FIG. 3 is a deployed diagram with straight lines of the section of the device for the assembly of the friction plate for the lockup clutch of the invention.

FIG. 4 is a diagram by an ichnography of the pressing component which includes the lower part of the circle ring form and the base component which includes the circle ring groove of the device for the assembly of the friction plate for the lockup clutch of the first embodiment of the invention.

FIG. 5 is a diagram which indicates the movement of the supply of the device for the assembly of the friction plate for the lockup clutch of the first embodiment of the invention.

FIG. 6 is a diagram which indicates the movement of the supply of the device for the assembly of the friction plate for the lockup clutch of the third embodiment of the invention.

FIG. 7 is a diagram which indicates the movement of the punching out of the supply of the device for the assembly of the friction plate for the lockup clutch of the fourth embodiment of the invention.

### DETAILED DESCRIPTION OF THE INVENTION

Preferred embodiments of the invention are described hereinafter based on drawings. Further, regarding embodiment of the invention, the same sign and the same symbol is the same or the equivalent function part, therefore the overlapped explanation is to be omitted here.

### First Embodiment

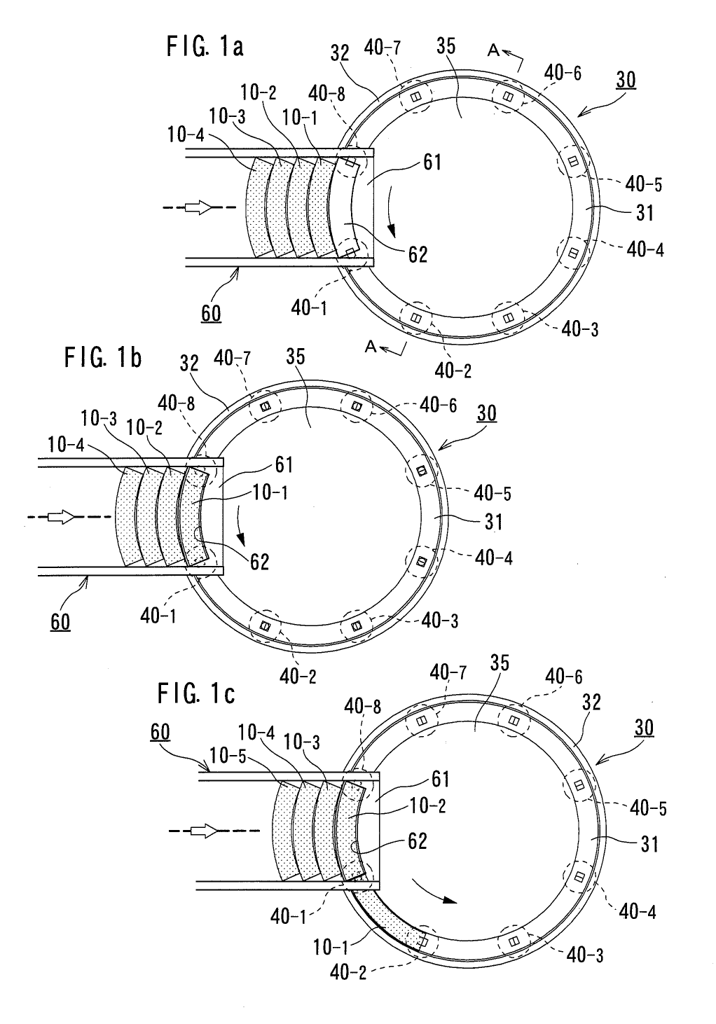

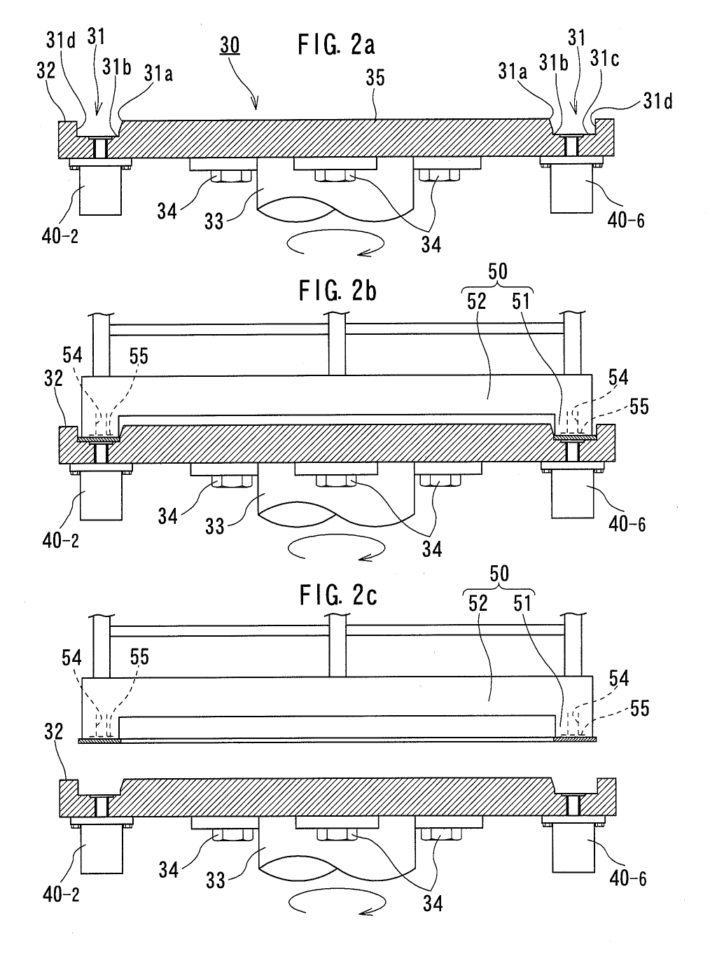

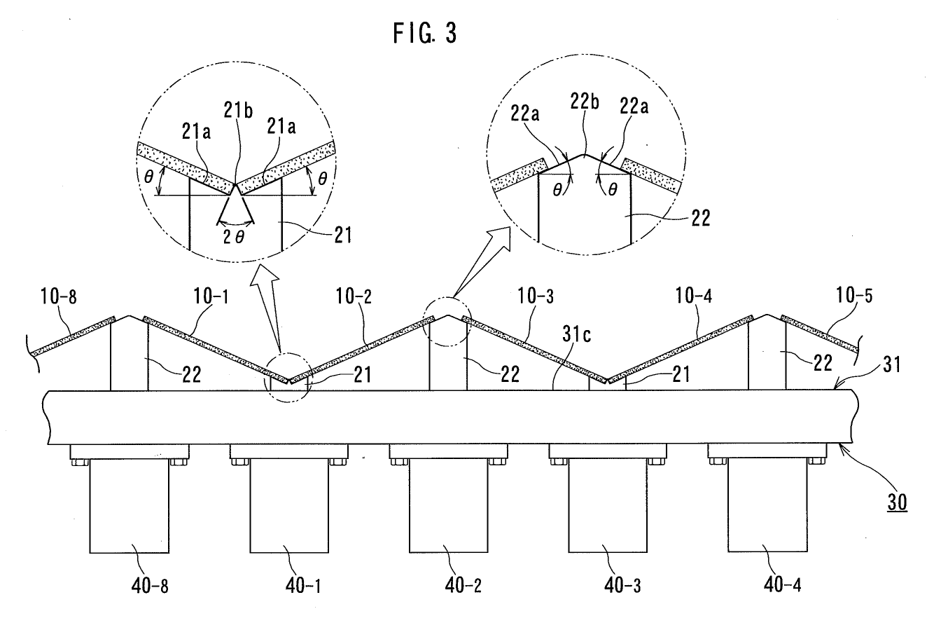

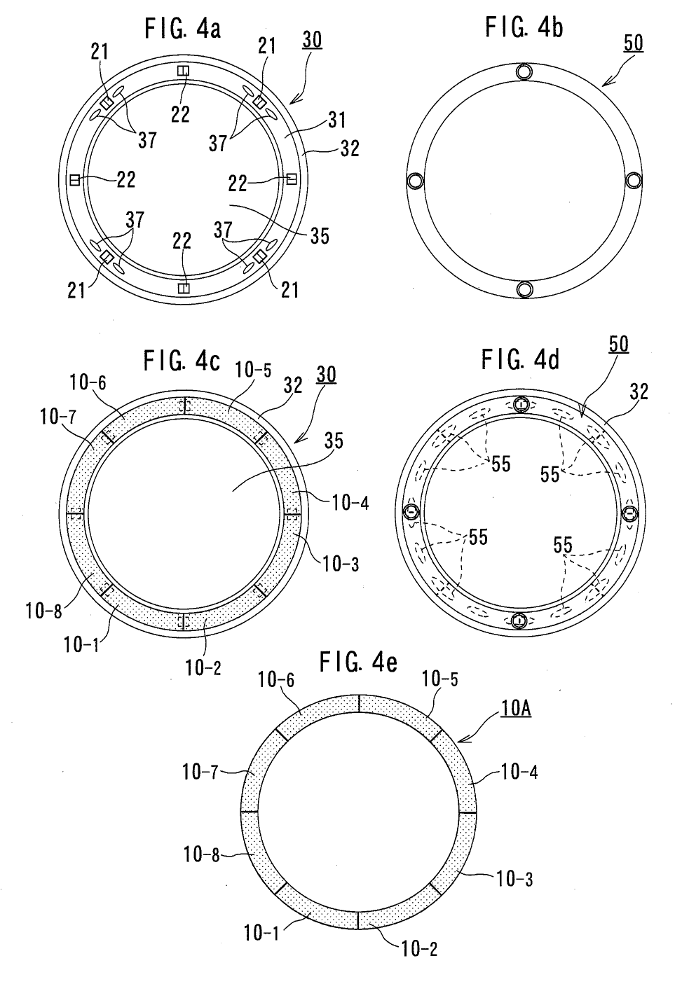

According to the first embodiment of the invention, there is provided FIG. 1 which is a view which indicates the whole movement of a device for an assembly of a friction plate for the lockup clutch and FIG. 2 is a cross sectional view through the cutting line A-A of FIG. 1. Also, according to the first embodiment of the invention, there is provided FIG. 3 which is a rectilinearly deployed view of the section of a device for an assembly of a friction plate for the lockup clutch. Moreover, according to the first embodiment of the invention, there is provided FIG. 4 which is a diagram through a plane figure of the pressing component including the lower part of the circle ring form and the base component including the circle ring groove of the device of the assembly of the friction material for the lockup clutch.

Regarding embodiment of the invention, the fan-shaped friction material 10 (what follows, regarding the present embodiment, is indicated as “10” for the fan-shaped friction material is that the position is not specified and “10-1˜10-8″ for the fan-shaped friction material is that the position is specified.) is that is punched out in other place which is not indicated in Figure and is to push out the channel of supply 60 consecutively. Yet, in case of enforcing the invention, the supply of the fan-shaped friction material 10 can be supplied to the circle ring groove 31 of the base component 30 which is formed as the molding die of the circle formed friction material 10A directly after enforcing punching out.

Hereupon, the circle form friction material 10A is to be recognized to be indicated the circle formed friction material which is formed by the several pieces of the fan-shaped friction material 10. “The several” indicates the example of the 8 pieces of the fan-shaped friction material 10 here, however in case of enforcing the invention the number of the pieces is not defined but is acceptable when it is more than 2 pieces.

The whole form of the plane figure of the base component 30 forms the circle form and it is that the circle ring groove 31 is formed on the concentric circle. The base component 30 and the circle ring groove 31 are made from the metal and the internal side of the outer circumference of the circle ring groove 31 is equivalent to the outer circumference of the circle formed friction material 10A which is formed by the several pieces of the fan-shaped friction material 10. What is more, the internal side of the upper part is made smaller than the inside diameter of the circle formed friction material 10A and it is nearly equivalent to the inside diameter of the circle formed friction material 10A at the internal side of the underside.

That is, the center disk part 35 of the base component 30 is, as being indicated in FIG. 2, that the mutual space of the upper part edge part 31a which goes along the center is made shorter than the distance of the mutual space of the lower part edge part 31b which as well goes along the center so that the distance of the mutual space of the edge part which goes along is made to be increased in proportion to the depth of the circle ring groove 31. Also the inside 31d of the outer circumference wall 32 of the base component 30 is formed perpendicularly from the underside 31c of the circle ring groove 31 which is made smooth surface. The undersurface side of this base component 30 receives the turning force, that the power source which is not indicated in figures is controlled, and is fixed with the bolt 34 on the axis of rotation 33 being made capable of rotation. What is more, the supporting component of the lower end side 21 and the supporting component of the upper end side which is controlled by the oil pressure cylinder, the air cylinder or the magnetism solenoid is positioned at the underside of the base component 30. It is to be controlled by the air cylinder 40-1˜40-8 in this embodiment.

The supporting component of the lower end side 21 is a square pillar rod which receives the lower edge of the fan-shaped friction material 10 which is positioned, in this embodiment, 8 pieces at every designated circumference of the circle ring groove 31 of the base component 30 and also the supporting component of the upper end side 22 is a square pillar rod which receives the upper edge of the fan-shaped friction material 10 which is positioned at every designated circumference of the circle ring groove 31 of the base component 30.

The height of the supporting component of the lower end side 21 is low, under normal conditions the height is not regard as important however it is formed at the height of minimum from 0 mm to 15 mm.

Specifically as the enlarged drawing of FIG. 3 shows, the inclination angle θ of the both side inclination side 21a is to be decided depending on the positioning angle of the fan-shaped friction material 10. Especially regarding this embodiment, the projection 21b which is to decide the position is provided at the center of the supporting component of the lower end side 21. This projection 21b which is to decide the position is that the angle of the projection is decided depending on the angle of the edge part of the fan-shaped friction 10 and the angle is made to approximately 2 θ which is inclined to the both sides by angle θ. The height of the projection 21b which is to decide the position is generally made less than the thickness of the fan-shaped friction material 10, however it is acceptable if it is what can maintain a slide with the fan-shaped friction material 10 even if it is thicker than the relevant. The thickness of the lower edge of the projection 21b which is to decide the position is desirable either that the upper part of the edge part of the mutual space of the fan-shaped friction material 10 is contacting or the thin gap, for example the gap proportion of 0.1 mm at the upper part of the edge part of the mutual space of the fan-shaped friction material 10.

The square pillar rod is used as the supporting component of the lower end side 21 and the fan-shaped friction material 10 is what is formed at the circle formed friction material 10A, therefore precisely, it is corrected to make the thickness of slightly inside of the projection angle of the projection 21b which is to decide position thin toward the central axis of the circle formed friction material 10A. This correction of thickness is nearly within the range of the error due to that the fan-shaped friction material 10 presents the form which the circle formed friction material 10A is cut in a radical manner from the beginning and the contacting precision between the projection 21b which is to decide position and the edge part of the fan-shaped friction material 10 becomes better so that that ideal result was able to be gained through the invention by the inventors.

Yet, this supporting component of the lower end side 21 is made not capable of revolution against the circle ring groove 31, therefore the square pillar rod is used. It is acceptable if this has the function which to prevent the revolution of the key groove etc. even though it is a round pillar rod.

The supporting component of the upper end side 22 is the square pillar rod which receives the upper edge of the fan-shaped friction material 10 which is positioned 4 pieces at every designated circumference of the circle ring groove 31 of the base component 30, in this embodiment, the midway of mutual of supporting component of the lower end side 21. The height of the supporting component of the upper end side 22 is not regard as important under normal conditions, however it is formed at the height the maximum from 10 mm to 40 mm.

Specially, as the enlarged drawing of FIG. 3 shows, the height is decided by the length of the fan-shaped friction material 10 and the inclined angle θ of the both sides inclination 21a of the circle formed friction material 10A, that is, the positioned angle of the friction material in which is the fan-shaped 10. Especially, regarding this embodiment, the upper edge 22b and the both sides inclination 22a of the supporting component of the upper end side 22 are inclined only by the angle θ at the both sides depends on the positioned angle of the fan-shaped friction material 10. Moreover, the upper edge 22b has been planed off the edges to make it smooth.

The square pillar rod is used as the supporting component of the upper end side 22 and the fan-shaped friction material 10 is to be formed on the circle formed friction material 10A, therefore precisely, the length of the upper edge 22b is formed toward the central axis of the circle formed friction material 10A.

The projection angle of the upper edge 22b is also corrected as that the thickness of the inside is slightly thin. This correction of thickness is that the fan-shaped friction material 10 is originally presented the form as that the circle formed friction material 10A is cut in a radical manner so that the contacting resistance between the edge part of the fan-shaped friction material 10 and the projection 21b which decides the position becomes smaller by providing as that the projection angle of the upper edge 22b is also that the thickness of the inside is slightly thinner and also the mutual space of the fan-shaped friction material 10 is contacted when the supporting component of the upper end side 22 declines. In that occasion, the slight adjustment of precision is induced so that it was able to be gained the suitable result at the experimentation of inventors.

Further, this supporting component of the upper end side 22 is not made capable of revolution against the circle ring groove 31, therefore the square pillar rod is used, however it is acceptable if the function which prevents the revolution of key groove etc. is provided even if a round pillar is used.

Regarding this embodiment, the both supporting component of the lower end side 21 which receives the lower edge of the fan-shaped friction material 10 which is positioned at every 90 degrees which is the every designated circumference at the nearly center of the groove (the groove of the diameter direction) of the circle ring groove of the base component 30 and the supporting component of the upper end side 22 which receives the upper edge of the fan-shaped friction material 10 which is positioned at every 90 degrees at the center position of the mutual space of the supporting component of the lower end side 21 are controlled separately by the air cylinder 40 (which may, hereinafter in this embodiment, be referred to as 40 regarding the air cylinder which does not specify the position and it is to be indicated as 40-1˜40-8 regarding the air cylinder which specifies the position.), however the each 4 pieces of the both supporting component of the lower end side 21 and the supporting component of the upper end side 22 can be controlled the ascent and descent at the same time with the single air cylinder and also the 4 pieces of the supporting component of the lower end side 21 and the 4 pieces of the supporting component of the upper end side 22 can be controlled the ascent and descent at the same time by separating in two with 2 air cylinders.

The pressing component 50 which is capable of inserting into the circle ring groove 31 of the base component 30 is that the several pieces of the fan-shaped friction material 10 which are formed in a line on the circle ring groove 31 is to compress to make that the several pieces of the friction material 10 to the circle formed friction material 10A of the circle form while retracting the supporting component of the lower end side 21 and the supporting component of the upper end side 22.

The pressing component 50 is that the circle ring formed lower part 51 which the lower side is in the circle ring form as the degree of that the lower part fits to the circle ring groove 31, at the same time, it is formed into the mechanical precision at the degree of from 0.1 to 1 mm to the diameter direction and the circle ring formed lower part 51 is that the upper part is formed into one body with the flame 52.

The air conduit 54 and as well as the absorbing head 55 which are not indicated in Figures are formed inside the circle ring formed lower part 51 and it is structured to absorb by the absorbing head 55 of the lower edge of the circle ring formed lower part 51. For that reason, the air conduit 54 is put in plumbing at both the inner part and the outer part of the flame 52. The fan-shaped friction material 10 which is absorbed by the absorbing head 55 of the lower edge of this circle ring formed lower part 51 is at the condition of that is formed in a line as the circle formed friction material 10A, therefore it is made to absorb the midway and also its edge part of the fan-shaped friction material 10. Especially, if the edge part of the side of the supporting component of the lower end side 21 of the fan-shaped friction material 10 is absorbed, for example by the absorbing head 37, a basis point of the fan-shaped friction material 10 is specified, consequently it becomes easy to guide to circle formed friction material 10A.

Subsequently, it is to explain regarding the movement of the device of assembly of the friction plate for the lockup clutch of the first embodiment of the present invention which is structured as this.

The fan-shaped friction material 10 which is punched out at another spot which is not indicated in Figure is sent off the channel of supply 60 which is indicated in FIG. 1 successively.

The fan-shaped friction material 10 is sending off successively as the center positions at the direction of the sending off. The sending off of this fan-shaped friction material 10 is enforced by the device of supply which is not indicated in the figure. It is the one that the stopping position guide 61 is formed at the edge part of the channel of supply 60. It falls from the mouth of the channel of supply 62 when the inside diameter side of the fan-shaped friction material 10 touches the stopping position guide 61, however to make it perfect, it is moved to the downward direction by the pressing rod that the external form of the fan-shaped friction material 10 is made a size smaller.

It is a little spacing from the mouth of the channel of supply 62 to the supporting component of the upper end side 22 of the circle ring groove 31 and the fan-shaped friction material 10 which drops receives a force of vector by the slope 22a of the supporting component of the upper end side 22, however its external force is small and the fan-shaped friction material 10 revolves by putting the slope 22a of the supporting component of the upper end side 22 as a fulcrum. The fan-shaped friction material 10 transfers on the slope 21a by the time the lower edge of the fan-shaped friction material 10 reaches the supporting component of the lower end side 21 and the fan-shaped friction material 10 contacts to the projection 21b which is to decide the position of the center of the supporting component of the lower end side 21. In consequence, the fan-shaped friction material 10 placed in between with the supporting component of the upper end side 22 due to that the projection 21b which is to decide the position becomes the standard at the center of the supporting component of the lower end side 21.

To take an illustration, FIG. 1a indicates the condition of the immediately before that the internal side of the fan-shaped friction material 10-1 of the channel of supply 60 reaches to the channel of supply 62. In succession, FIG. 1b indicates the condition of the immediate before that the internal side of the fan-shaped friction material 10-1 is contacted to the stopping position guide 61 of the edge part of the channel of supply 60 and it drops from the mouth of the supply 62. FIG. 1c indicates the condition of the immediate before that the base component 30 is rotated by 45 degrees moreover from the placement of the fan-shaped friction material 10-1 of FIG. 1b and the fan-shaped friction material 10-2 is that the inside diameter of the fan-shaped friction material 10 is contacted to the stopping position guide 61 of the edge part of the channel of supply 60 and it is to drop from the mouth of the supply 62. Furthermore, the fan-shaped friction material 10-1 which is dropped from the mouth of the supply 62 of the channel of supply 60 is the one which indicates the condition that is placed on the supporting component of the lower end side 21 and the supporting component of the upper end side 22 and the base component 30 is rotated by only 45 degrees.

Thus, it is to place the fan-shaped friction material 10 on the upper part of the supporting component of the upper end side 22 and the supporting component of the lower end side 21 of the circle ring groove 31 successively by rotating the base component 30 by 45 degrees successively. At this time, as it is indicated in FIG. 3, it is a small spacing from the mouth of supply 62 to the supporting component of the upper end side 22 of the circle ring groove 31 and the fan-shaped friction material 10 which drops contacts the slope 22a of the supporting component of the upper end side 22 as the earliest. To explain this at some length, the fan-shaped friction material 10 which contacts to the slope 22a receives the force of vector by its weight, however the air resistance is large and the external force of the direction which is to slide the slope 21a is small. In consequence, it becomes that the fan-shaped friction material 10 rotates by putting the slope 22a of the supporting component of the upper end side 22 as a fulcrum. The fan-shaped friction material 10 slightly moves on the slope 21 by the time that the lower edge of the fan-shaped friction material 10 reaches to the supporting component of the lower end side 21, however the fan-shaped friction material 10 contacts to the projection 21b which is to decide the position at the center of the supporting component of the lower end side 21.

A matter of course, the disk part 35 of the center is that mutual space of the upper part edge part 31a which goes through the center is made shorter than the distance of between one another of lower part edge part 31b and the distance between one another of the edge part which goes through the center of the base component 30 is made to be increased being in proportion to the depth of the circle ring groove 31 so that the fan-shaped friction material 10 which is to be dropped to the circle ring groove 31 receives the adequate air resistance, as occasion demands at need, there is possibility that is to be fixed at the designated position by being guided by the interior 31d of the wall of the outer circumference 32 of the circle ring groove 31 of the base component 30.

Thus, the projection 21b which is to decide the position at the center of the supporting component of the lower end side 21 is being the standard, the fan-shaped friction material 10 is placed at midway with the supporting component of the upper end side. The edge part of the fan-shaped friction material 10 of the side of the supporting component of the lower end side 21 is normally at the condition of the one another lightly contacts.

At this condition, it is to set the 8 pieces of the fan-shaped friction material 10 between the supporting component of the lower end side 21 and the supporting component of the upper end side 22 as putting it across.

To take an illustration, the 8 pieces of the fan-shaped friction material 10 descend by translating to the designated position when descending the supporting component of the lower end side 21 and the supporting component of the upper end side 22 at the same time. When the lowest position of the upper part of the supporting component of the lower end side 21 is transferred to the downward direction than the bottom side 31c of the circle ring groove 31, the lower edge of the 8 pieces of the fan-shaped friction material 10 gets obstructed to transfer and the upper parts of the lower edge of one another of the 8 pieces of the fan-shaped friction material 10 contact. Upon this, furthermore, when the supporting component of the lower end side 21 and the supporting component of the upper end side 22 descend, the upper part of the 8 pieces of the fan-shaped friction material 10 rotates stating the upper part of the lower edge of the 8 pieces of the fan-shaped friction material 10 as a fulcrum.

When the upper part of the 8 pieces of the fan-shaped friction material 10 revolves by putting the upper part side of the lower edge of the 8 pieces of the fan-shaped friction material 10 as a fulcrum, the upper part of the 8 pieces of the fan-shaped friction material 10 ascends the slope 21a and the one another's upper parts of the 8 pieces of the fan-shaped friction material 10 run onto the upper edge 22b which is planed off the edges. And furthermore, when the upper end side supporting friction material 22 descends, the lower part of the upper edge part of the 8 pieces of the fan-shaped friction material 10 contacts and the edge part of the upper end side and the lower end side of the 8 pieces of the fan-shaped friction material 10 contiguously.

At this condition, the 8 pieces of the fan-shaped friction material 10 becomes the circle formed friction material 10A which the 8 pieces are continuous. However, the contact of the edge part of the 8 pieces of the fan-shaped friction material 10 if left to the care of its weight so that possibly there is necessarily the one which the contact of the mutual of the end sides are not congruent. Upon this, to compress the circle formed friction material 10A to the bottom side 31c of the circle ring groove 31 by making use of the circle ring formed lower part 51 of the pressing component 50 at the condition that the 8 pieces of the fan-shaped friction material are formed in a line as the circle form at the circle ring groove 31 of the base component 30, to take the smooth side of the circle formed friction material 10A out and to form it at the circle form as if it is the circle formed friction material 10A which there are 8 lines of the radical slits.

Then with this condition, it is to be absorbed from the absorbing head 55 which is placed at the circle ring formed lower part 51 of the pressing component 50, to maintain the circle formed friction material 10A at the downward side of the circle ring formed lower part 51 and to transfer it to the joining process and the adhesive application process against the piston material of the lockup clutch or the core grid of the next lockup clutch.

Further, the explanation which is to supply the supply of the fan-shaped friction material 10 from the single channel of supply 60 has been enforced in this embodiment, however the supply of the fan-shaped friction material 10 can be supplied from 2 channels of supply 60 as well.

### Second Embodiment

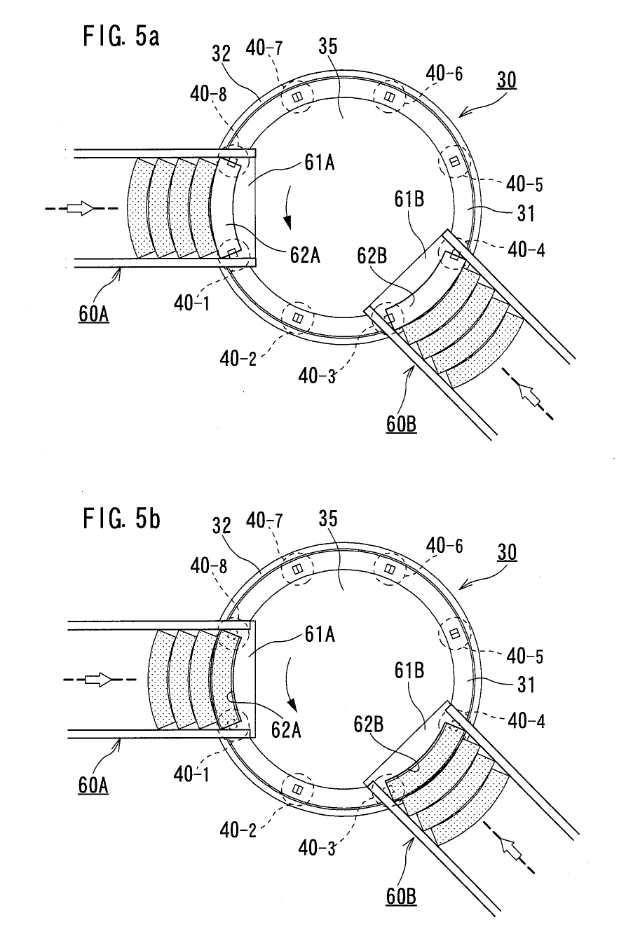

FIG. 5 is the diagram which indicates the movement of supply of a device for an assembly of a friction plate for the lockup clutch of the second embodiment of the present invention.

Regarding embodiment of the invention, the fan-shaped friction material 10 is what is to be punched out at the other place which is not indicated in the figure and is to be sent off the single channel of supply 60 successively. However, the fan-shaped friction material 10 is that the angle θ alternates between one another so that it is transferred horizontally as first embodiment and then the method which is to make it to the designated inclination is adopted. However, there is possibility that the line up error may occur because the influence of the air resistance is large depending on the size or the weight of the fan-shaped friction material 10.

Thereupon at this embodiment, it is to set the drop of the fan-shaped friction material 10 as it is to reach the upper edge of the supporting component of the upper end side 22 and the supporting component of the lower end side 21.

As it is indicated in FIG. 3, the inclination angle differs depending on the odd number and the even number in case of using the several pieces of the fan-shaped friction material 10. Thereupon, it is the one which adopted the channel of supply 60A of the fan-shaped friction material 10 for the odd number and the channel of supply 60B of the fan-shaped friction material 10 for the even number. The channel of supply 60A of the fan-shaped friction material 10 for the odd number and the channel of supply 60B of the fan-shaped friction material 10 for the even number enforce the supplying motion of the fan-shaped friction material 10 being synchronized to one another.

The channel of supply 60A for the fan-shaped friction material 10 for the odd number is the one which is inclined to the right direction by the angle θ towards the supplying progress direction, and also the channel of supply 60B of the fan-shaped friction material 10 for the even number is the one which is inclined to the left direction by the angle θ toward the supplying progress direction.

First, it is to form a notch at the wall of the outer circumference 32 or the upper part of the wall of the outer circumference 32 of the circle ring groove 31 of the base component, and then it is to place the channel of supple 60A of the fan-shaped friction material 10 for the odd number and the channel of supply 60B of the fan-shaped friction material 10 for the even number there.

In the case of this example of the enforcement, the distance to the edge part of the supporting component of the lower end side 21 and to the edge part of the supporting component of the upper end side 22 are fixed so that the natural transfer of the fan-shaped friction material 10 can be performed. In the case of this enforcement, it is desirable that it is to be transferred to the downward direction by the pressing rod which its external shape of the fan-shaped friction material 10 is the size smaller. Thus, the supplying process is able to be enforced from the single channel of supply 60 as the channel of supply 60A of the fan-shaped friction material 10 for the odd number and the channel of supply 60B of the fan-shaped friction material 10 for the even number which are inclined oppositely to one another and it is able to be expected that the productivity gets improved because of that there is no abnormality on the supply of the fan-shaped friction material 10 and the velocity of the supply of the fan-shaped friction material 10.

### Third Embodiment

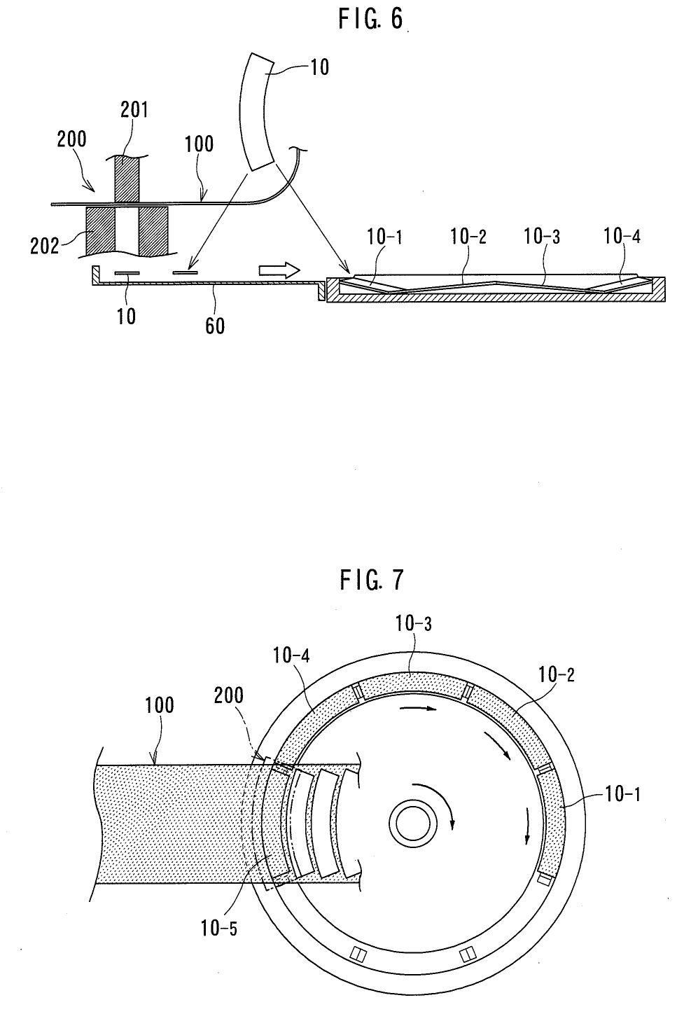

FIG. 6 is a diagram which indicates the movement of supply of the device for assembly of the friction plate for the lockup clutch of the third embodiment of the invention.

Regarding the third embodiment of the invention, it is to be punched out as the fan-shaped friction material 10 from the friction material 100 which is the material of the shape of a belt with the device 200 of punching out which is made out of the movable die 201 such as a press and the fixed die 202 and that can be supplied from the single plane surface of the single channel of supply 60. Furthermore, the fan-shaped friction material 10 which is punched out with the device 200 of punching out such as a press is able to be supplied from the inclined surfaces of the channel of supply 60A of the fan-shaped friction material 10 for the odd number and the channel of supply 60B of the fan-shaped friction material 10 for the even number which are inclined oppositely to one another.

### Fourth Embodiment

FIG. 7 is a diagram which indicates the movement of the punching out of the supply of a device for an assembly of a friction plate for the lockup clutch of the fourth embodiment of the invention.

Regarding the fourth embodiment of the invention, it is to punch out the fan-shaped friction material 10 from the friction material 100 with the device 200 for punching out which is made out of the movable die 201 and the fixed die 202 such as the press and then it is to lead the fan-shaped friction material 10 which is punched out directly to the upper edge part of the supporting component of the lower end side 21 and the supporting component of the upper end side 22. Hereupon, it displays the precision of the transferring by that the movable die 201 transfers the fan-shaped friction material 10 to the upper edge part of the supporting component of the lower end side 21 and the supporting component of the upper end side 22 while punching out the fan-shaped friction material 10.

As stated above, the device for the assembly of the friction plate for the lockup clutch of the form of the above mentioned enforcement of the invention is capable of inserting the several pieces of the fan-shaped friction material 10 inside the groove of the base component 30 which formed the circle ring groove 31 which is positioned as the circle ring form, the supporting component of the lower end side 21 which props up the lower edge of the fan-shaped friction material 10 which is positioned at the every designated circumference of the circle ring groove 31 of the base component 30, the supporting component of the upper end side 22 which props up the upper edge of the fan-shaped friction material 10 which is positioned at the every designated circumference of the circle ring groove of the base component 30 and the circle ring groove 31 of the base component 30 and then the several pieces of the fan-shaped friction material 10 which is formed in a line at the circle ring groove 31 are fully provided also with the compressing component 50 which compresses the several pieces of the fan-shaped friction material 10 to form into the circle formed friction material 10A while retracting the supporting component of the lower end side 21 and the supporting component of the upper end side 22.

In consequence, it can take out the several pieces of the fan-shaped friction material 10 as the circle formed friction material 10A without necessarily using the wider space than the circle ring groove which is formed at the base component 30 so that the manufacturing can be performed with the small space of the square measure of the setting for the device. Also the circle ring groove 31 which is formed at the base component 30 is, different from the existed examples, fixed and also is not something which has the surplus space so that the fan-shaped friction material 10 does not move by the centrifugal force even though in case of supplying it by rotating the several pieces of the fan-shaped friction material 10 successively, therefore the operation of the high velocity becomes possible. Furthermore, it is to position the several pieces of the friction material 10 to the circle ring groove 31 as those are inclined oppositely to one another and is something which is to adjust the several pieces of the friction material 10 which are contiguous to the circle form so that the joining density of the edge part becomes high and there is no possibility that the mechanical intensity lowers at the boundary line of the fan-shaped friction material 10.

What is more, it is able to be stated as embodiment which full provides the work transferring method, which absorbs the circle formed friction material 10A, which absorbs the several pieces of the fan-shaped friction material 10 at the condition made as circle formed friction material 10A and which transfers the spot of the circle formed friction material 10A on the compressing component 50.

In consequence, in case of transferring it to the next working process, it is able to be used without that the form of the circle formed friction material 10A is getting out of shape by absorbing the several pieces of the fan-shaped friction material 10 at the condition of that is formed into the circle formed friction material 10A, therefore it is able to raise precision at the finishing.

The circle ring groove 31 of the base component 30 is that the form of the section of the diameter direction, that is the mutual space of the edge part 31a of the upper part which goes through the center, is made shorter than the distance of the mutual space of the edge part 31b of the lower part which as well goes through the center so that is able to be stated as embodiment which is formed into the trapezoid which the upper side is made wider. In consequence, while transferring the fan-shaped friction material 10 to the specified molding position, that is, the molding position of the bottom side 31c, it is guided at the side and the several pieces of the fan-shaped friction material 10 is able to be precisely formed into the circle formed friction material 10A.

Moreover, the section formed trapezoid of the diameter direction of the base component 30 is able to be stated as embodiment which the outer circumference side does not change but only internal circumference is changed. In consequence, the section formed trapezoid of the diameter direction of the base component 30 is that the outer circumference does not change but only the internal circumference is changed, so that the several pieces of the fan-shaped friction material 10 is able to be precisely formed into the circle formed friction material 10A by stating the internal side 31d of the wall of the outer circumference 32 of the circle ring groove 31 of the base component 30 as a reference plane even if the centrifugal force affects and by being guided by the internal side 31d.

The device for assembly of the friction plate for the lockup clutch of embodiment of this above mentioned invention can be adopted as the method of assembly of the friction plate for the lockup clutch.

Which means, the method of assembly of the friction plate for the lockup clutch of embodiment of this above mentioned invention is what fully provides that the supporting component setting process which set both the supporting component of the lower end side 21 which props up the lower edge of the fan-shaped friction material 10 which is positioned at the every designated circumference of the circle ring groove 31 which is formed into the base component 30 and as well as the supporting component of the upper end side 22 which props up the upper edge of the fan-shaped friction material 10 which is positioned at the every designated circumference at the each designated heights, the supplying process which positions the several pieces of the fan-shaped friction material 10 of the circle ring groove 31 which is formed into the base component 30 at the upper edge of the supporting component of the lower end side 21 and the supporting component of the upper end side 22 which are contiguous as those becomes oppositely inclined and the compressing process which compresses the several pieces of the fan-shaped friction material 10 which are formed in a line at the circle ring groove 31 is to intend to form the circle formed friction material 10A by retracting the supporting component of the lower end side 21 and the supporting component of the upper end side 22 and as well by contacting the edge part of the several pieces of the fan-shaped friction material 10.

In consequence, the manufacturing is able to be performed with that the several pieces of the fan-shaped friction material 10 is able to be taken out as the circle formed friction material 10A without using the wider space than the circle ring groove 31 which is formed at the base component 30 and also that the setting square measure of the device is small. Also, the circle ring groove 31 which is formed at the base component 30 is, different from the existed examples, fixed and is not something which has the surplus space so that the high velocity operation becomes possible because that the friction material in which is fan-shaped does not transferred by the centrifugal force even in the case of supplying it by rotating the several pieces of the fan-shaped friction material 10 successively.

Moreover, it is to position the several pieces of the fan-shaped friction material 10 on the circle ring groove 31 by intending one another to be inclined oppositely and it is to adjust the several pieces of the fan-shaped friction material 10 which are contiguous as the circle form so that the joining density of the edge part becomes high and there is no possibility that the mechanical intensity lowers at the boundary line of the fan-shaped friction material 10.

Moreover, it can be performed as embodiment which fully provides the work transferring process which transfers the position of the circle formed friction material 10A by absorbing the circle formed friction material 10A which is formed into the circle form at the condition of that is formed into the circle form after the above mentioned compressing process. In consequence, it is able to higher the finishing precision because that can be used without getting out of the form of the circle formed friction material 10 by absorbing the several pieces of the friction material 10 at the condition which is formed into the circle form in case of transferring it to the next working process.

In the above mentioned supplying process, it can be performed as embodiment which supplies the fan-shaped friction material 10 which are made inclined oppositely to one another from the single channel of supply 60. In consequence, it is to supply the fan-shaped friction material 10 which is inclined oppositely to one another from the single channel of supply 60 so that it is able to structure the whole device in a compact way.

Also in the above mentioned supplying process, it is to supply the fan-shaped friction material 10 which is inclined identically to one another from the 2 channels of supply 60A and the 60B. In consequence, it is able to perform the precise finishing because the fan-shaped friction material 10 is able to be set correctly due to that is to supply the fan-shaped friction material 10 which is inclined identically to one another from 2 channels of supply 60A and the 60B.

The above mentioned supporting component setting process is able to be performed as embodiment which is started duplicated to the work transferring process at the continuous operation. In consequence, the above mentioned supporting component setting process of the method for the assembly of the friction plate for the lockup clutch is what is started supplicated to the work transferring process at the continuous operation so that the productivity can be raised.

Regarding the method for the assembly of the friction plate for the lockup clutch of embodiment of the invention, the above mentioned supporting component setting process is what is to set the supporting component of the lower end side 21 and the supporting component of the upper end side 22 at the designated height as to be able to position the fan-shaped friction material 10 to the supporting component of the lower end side 21 and the supporting component of the upper end side 22 by the designated angle and the supporting component of the lower end side 21 and the supporting component of the upper end side 22 are controlled to intend to the each set designated height.

Also, the above mentioned supplying process is what is to place the several pieces of the fan-shaped friction material 10 inside the circle ring groove to the upper edge of the supporting component of the lower end side and the supporting component of the upper end side 22 which are contiguous to be inclined oppositely to one another at the circle ring form and it can supply the fan-shaped friction material 10 which is inclined oppositely to one another from the single channel of supply and also can supply the fan-shaped friction material 10 which is inclined identically to one another from 2 channels of supply 60A and the 60B.

Moreover, the above mentioned supplying process is that the several pieces of the fan-shaped friction material 10 which are formed in a line at the circle ring groove 31 is what to compress to intend to make the circle formed friction material 10A by contacting the edge part of the several pieces of the friction material 10 while retracting the supporting component of the lower end side 21 and the supporting component of the upper end side 22. The retraction of the supporting component of the lower end side 21 and the supporting component of the upper end side 22 can be that retracts along with the pressing and also can be made to compress by retracting the supporting component of the lower end side 21 and the supporting component of the upper end side 22 positively.

What is more, after the above mentioned pressing process, it is to fully provide the work transferring process which is to absorb the circle formed friction material 10A which is formed into the circle form and then to transfer the spot of the above mentioned circle formed friction material 10A. Hereupon, the work transferring process is that forms the channel of supply 54 and the absorbing head 55 which absorb the circle formed friction material 10A which is formed into the circle form at the pressing component 50. It is acceptable if that is to transfer the position of the several pieces of the friction material which is formed into the above mentioned circle form into the other position and the transferring is acceptable even if it is such as a robot or a transferring machine.

It is to supply the fan-shaped friction material 10 which is inclined oppositely to one another from the single channel of supply at the above mentioned supplying process of the method for the assembly of the friction plate for the lockup clutch of the method for the assembly of the friction plate for the lockup clutch of this embodiment. Hereupon, the single channel of supply is what is able to punch out the single fan-shaped friction material 10 and at the same time is able to supply the fan-shaped friction material 10.

In the above mentioned supplying process of the method of the assembly of the friction plate for the lockup clutch of this embodiment, it is to supply the fan-shaped friction material 10 which is to be the identical inclination to one another from the 2 channels of supply 60A and the 60B. Hereupon, that the above mentioned 2 channels of supply 60A and the 60B is what to hold 2 groups of the channels of supply 60A and the 60B of the fan-shaped friction material 10 which is to be the identical inclination to one another. However it can be more than 2 groups in case of performing the present invention.

The above mentioned supporting component setting process of the method for the assembly of the friction plate for the lockup clutch of this embodiment is what is started duplicating with the work transferring process at the repeated operation. Hereupon, the above mentioned repeated operation can be the operation as a line of the assembly of the friction plate for the lockup clutch. Also, that is to be started duplicating with the work transferring process is acceptable if the above mentioned supporting component setting process and the work transferring process are to be started partially duplicated or duplicated in the whole.

Regarding the device for the assembly of the friction plate for the lockup clutch of this embodiment and as well the method of the assembly of the friction plate for the lockup clutch, it has been explained as an assumption of that the supporting component of the lower end side 21 and the supporting component of the upper end side 22 are at the set position, however in case of enforcing the invention, it can be first to prop up the fan-shaped friction material 10 which is supplied from the single channel of supply at the nearly identical height and then it can be made at the designated set position.

1. A device for an assembly of a friction plate for a lockup clutch comprising:
a supporting component of a lower end side, the supporting component of the lower end side props a base component that forms a circular ring groove, the circular ring groove arranges a plurality of fan-shaped friction materials in a circular ring shape, the supporting component of the lower end side also props a lower end of the fan-shaped friction materials mentioned above arranged at prescribed intervals of circumferences of the above circular ring groove of the above base component; and
a supporting component of a upper end side, the supporting component of the upper end side props a upper end of the fan-shaped friction materials mentioned above arranged at prescribed intervals of circumferences of the above circular ring groove of the above base component; and
a pressing component member, the pressing component member is capable of being inserted into inside of the above circular ring groove of the above base component, the pressing component member presses to make the above plurality of the fan-shaped friction materials be in a circular shape while retracting a plurality of fan-shaped friction materials arranged in the above circular ring groove side-by-side with the above supporting component of the lower end side and the above supporting component of the upper end side.

2. A device for an assembly of a friction plate for a lockup clutch according to claim 1 in which the above pressing component also has a work transportation device that absorbs the above plurality of the fan-shaped friction materials formed in the circular shape in condition of keeping the circular shape of the above plurality of the fan-shaped friction materials.

3. A device for an assembly of a friction plate for a lockup clutch according to claim 1 in which the circular ring groove of the above base component member has a cross-section shape cut in a direction of its diameter, which is formed in a trapezoid having a wide upper side.

4. A device for an assembly of a friction plate for a lockup clutch according to claim 3 in which the trapezoid of the cross-section shape cut in the direction of its diameter changes only an inner peripheral side without changing an outer peripheral side.

5. A method for an assembly of a friction plate for a lockup clutch comprising:
a supporting component setting process, the supporting component setting process sets a prescribed height for each supporting component, the supporting components includes a supporting component of the lower end side propping the lower end of fan-shaped friction materials arranged at prescribed circumferences of the circular ring groove formed in the base component, similarly a supporting component of the upper end side propping the upper end of the above fan-shaped friction materials arranged at prescribed circumferences is also included above; and
a supplying process, the supplying process arranges a plurality of fan-shaped friction materials of the circular ring groove formed in the above base component into upper ends of neighboring supporting component of the lower end side and the supporting component of the upper end side in a circular ring shape so as to be opposite incline each other; and
a pressing process, the pressing process is made to retract a plurality of fan-shaped friction materials arranged in the above circular ring groove side-by-side with the above supporting component of the lower end side and the above supporting component of the upper end side, the pressing process also presses to make the above plurality of the fan-shaped friction materials be in the circular shape.

6. A method for an assembly of a friction plate for a lockup clutch according to claim 5 in which after the above pressing process, there have a work transportation process that absorbs the above plurality of the fan-shaped friction materials formed in the circular shape in condition of keeping the above circular shape and moves a portion of the plurality of the fan-shaped friction materials formed in the above circular shape.

7. A method for an assembly of a friction plate for a lockup clutch according to claim 5 in which in the above supplying process, fan-shaped friction materials that are in the opposite incline each other are supplied from a single channel of supply.

8. A method for an assembly of a friction plate for a lockup clutch according to claim 5 in which in the above supplying process, fan-shaped friction materials that are in a uniform incline each other are supplied from two channels of supply.

9. A method for an assembly of a friction plate for a lockup clutch according to claim 6 in which the above supporting component setting process is started overlapping with the work transportation process in continued operations.

10. A device for an assembly of a friction plate for a lockup clutch according to claim 2 in which the circular ring groove of the above base component member has a cross-section shape cut in a direction of its diameter, which is formed in a trapezoid having a wide upper side.

11. A method for an assembly of a friction plate for a lockup clutch according to claim 6 in which in the above supplying process, fan-shaped friction materials that are in the opposite incline each other are supplied from a single channel of supply.

12. A method for an assembly of a friction plate for a lockup clutch according to claim 6 in which in the above supplying process, fan-shaped friction materials that are in a uniform incline each other are supplied from two channels of supply.
